(19) United States
(12) Patent Application Publication
(10) Pub. No.: US 2010/0046009 A1
(43) Pub. Date: Feb. 25, 2010

(54) SYSTEM AND METHOD FOR DOCUMENT PROCESSING HAVING PEER DEVICE DISCOVERY AND JOB ROUTING

(76) Inventors: Nayanatara S. PANDIT, Aliso Viejo, CA (US); Fabio Gava, Ladera Ranch, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/194,104

(22) Filed: Aug. 19, 2008

(51) Int. Cl. G06F 3/12

(52) U.S. Cl. 358/1.1

(57) ABSTRACT

The subject application is directed to a document processing device, system, and method having peer device feature discovery and job routing. Electronic document data is received from an associated document processing device, which electronic document data includes data corresponding to an electronic document and instruction data corresponding to a desired document processing operation associated with the document. Data corresponding to available features of the document processing device is compared relative to received instruction data. A prompt is generated to a second document processing device based upon the output of the comparison indicating that the document processing device has insufficient capabilities for performing the desired operation. Response data is received from the second device corresponding to capabilities of the second document processing device relative to the desired operation, and the electronic document data is routed to the second device in accordance with received response data.

### BACKGROUND OF THE INVENTION

The subject application is directed generally to networked document processing devices having differing capabilities. The application is particularly applicable to peer-based discovery of capabilities of various document processing devices to allow for efficient redirection of jobs among peers so as to allow efficient job completion.

Document processing devices include printers, copiers, scanners, and facsimile devices. More recent document processing devices include two or more of these functions and are referred to as multifunction peripherals (MFPs) or multifunction devices (MFDs). In addition to the functionality noted above, additional features are selectively available in such devices. By way of example, printers may have different or alternative sheet stock available or may have capabilities such as hole-punching, stapling, duplexing, n-up generation, collation, and the like. Some devices may include many printing features but lack facsimile capability.

Most office environments employ more than one document processing device, with each device having varying capability and being interconnected with user workstations and one another by a data network. A user will typically install a driver for each device for which access is desired, which typically includes devices proximate to each particular user. A user must be aware of the functionality of each device for which a driver is installed, and any attempt to send a desired job to a device with insufficient capability to complete the requested operation will result in failure.

### SUMMARY OF THE INVENTION

In accordance with one embodiment of the subject application, there is provided a document processing system and method having peer device feature discovery and job routing. Electronic document data is received from an associated document processing device, which electronic document data includes data corresponding to at least one electronic document and instruction data corresponding to at least one desired document processing operation associated with the at least one electronic document. Data corresponding to available features of the document processing device is compared relative to received instruction data. A prompt is generated to at least a second document processing device in accordance with an output of the comparison indicative of the document processing device having insufficient capabilities to perform the desired document processing operation. Response data is received from the second document processing device in accordance with a generated prompt, which response data includes data corresponding to capabilities of the second document processing device relative to the desired document processing operation, and the electronic document data is routed to the second document processing device in accordance with received response data.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a document processing system having peer device feature discovery and job routing according to one embodiment of the subject application;

FIG. 2 is a block diagram illustrating device hardware for use in the document processing system having peer device feature discovery and job routing according to one embodiment of the subject application;

FIG. 3 is a functional diagram illustrating the device for use in the document processing system having peer device feature discovery and job routing according to one embodiment of the subject application;

FIG. 4 is a block diagram illustrating controller hardware for use in the document processing system having peer device feature discovery and job routing according to one embodiment of the subject application;

FIG. 5 is a functional diagram illustrating the controller for use in the document processing system having peer device feature discovery and job routing according to one embodiment of the subject application;

FIG. 6 is a block diagram illustrating the document processing system having peer device feature discovery and job routing according to one embodiment of the subject application;

FIG. 7 is a functional diagram illustrating the document processing system having peer device feature discovery and job routing according to one embodiment of the subject application;

FIG. 8 is a flowchart illustrating a document processing method having peer device feature discovery and job routing according to one embodiment of the subject application; and

FIG. 9 is a flowchart illustrating a document processing method having peer device feature discovery and job routing according to one embodiment of the subject application.

### DETAILED DESCRIPTION OF THE PREFERRED EMBODIMENT

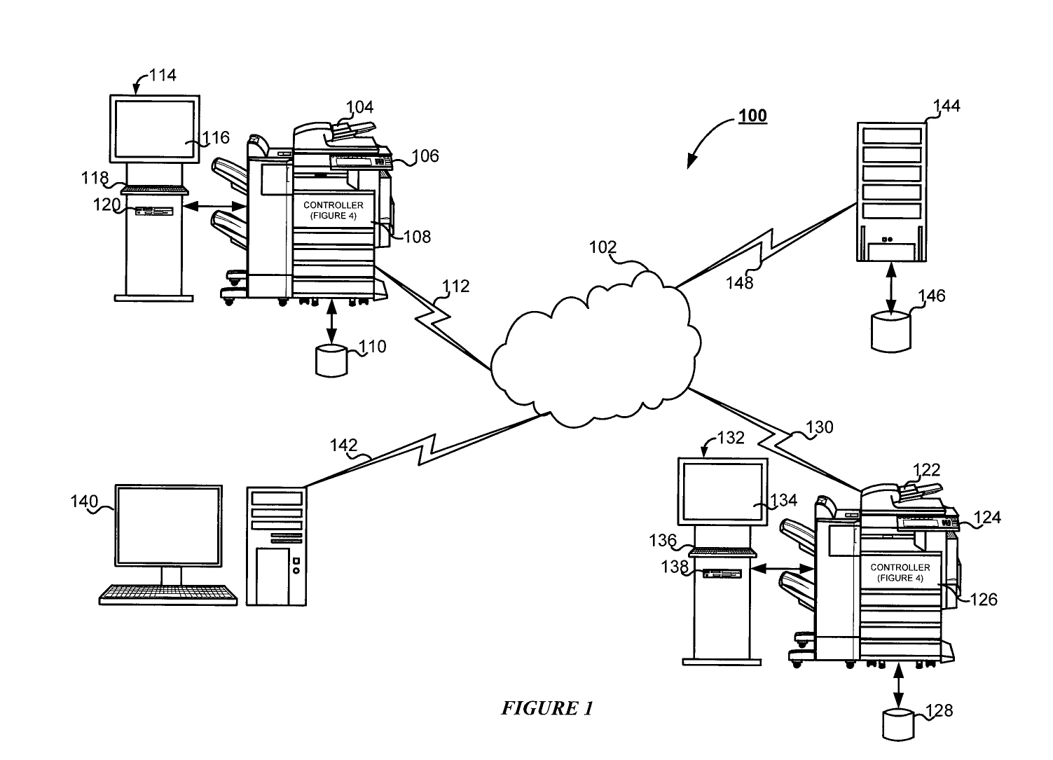

The subject application is directed to a document processing system and method having peer device feature discovery and job routing. In particular, the subject application is directed to a system and method for peer-based discovery of capabilities of various document processing devices to allow for efficient redirection of jobs among peers so as to allow efficient job completion. It will become apparent to those skilled in the art that the system and method described herein are suitably adapted to a plurality of varying electronic fields employing peer device communications including, for example and without limitation, communications, general computing, data processing, document processing, financial transactions, vending of products or services, and the like. The preferred embodiment, as depicted in FIG. 1, illustrates a document processing field for example purposes only and is not a limitation of the subject application solely to such a field.

Referring now to FIG. 1, there is shown an overall diagram of a document processing system 100 having peer device feature discovery and job routing in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a first document processing device 104 and a second document processing device 122, which are depicted in FIG. 1 as multifunction peripheral devices suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing devices 104 and 122 are suitably adapted to provide remote document processing services to external or network devices. Preferably, the document processing devices 104 and 122 include hardware, software, and any suitable combination thereof configured to interact with an associated user, a networked device, or the like.

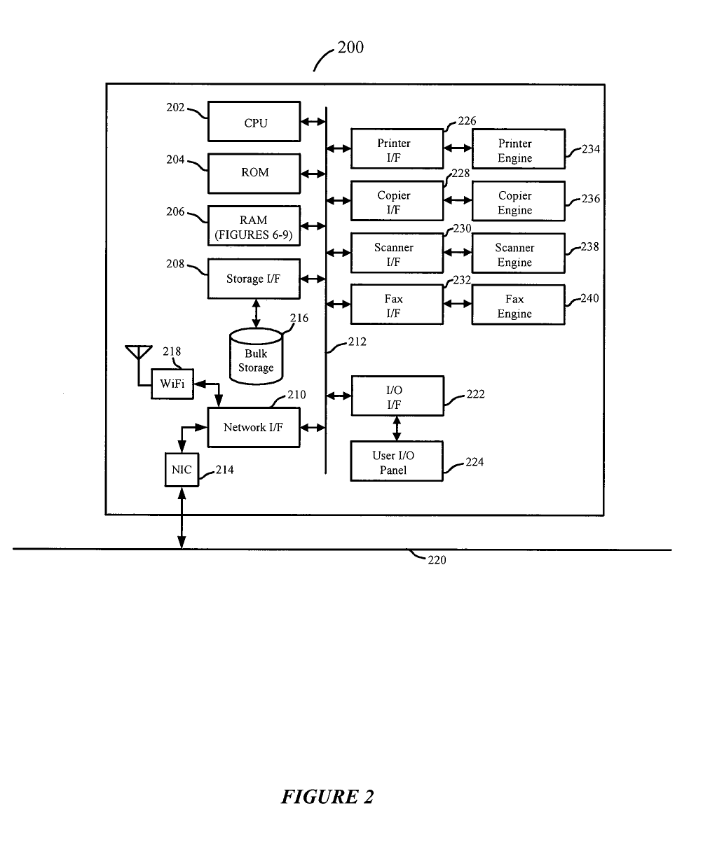

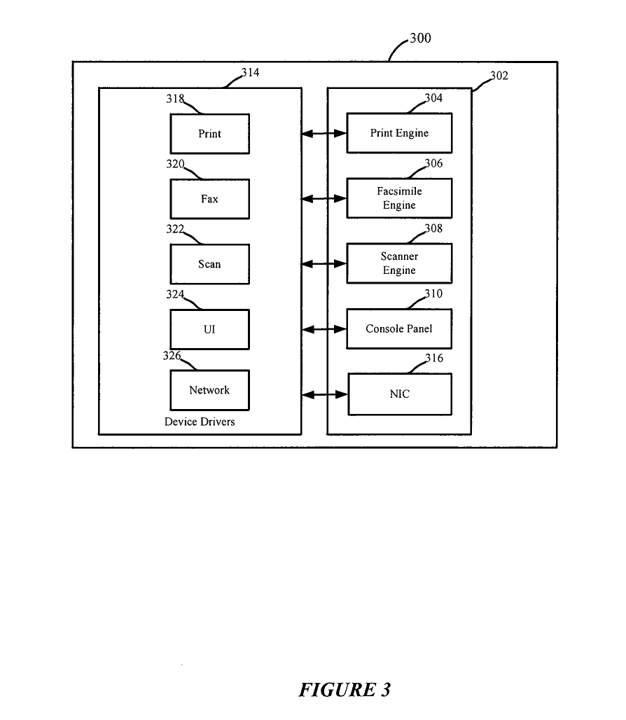

According to one embodiment of the subject application, the document processing devices 104 and 122 are suitably equipped to receive a plurality of portable storage media including, without limitation, Firewire drive, USB drive, SD, MMC, XD, compact flash, memory stick, and the like. In the preferred embodiment of the subject application, the document processing devices 104 and 122 further include an associated user interface 106 and 124, such as a touch-screen LCD display, touch-panel, alpha-numeric keypad, or the like, via which an associated user is able to interact directly with the corresponding document processing device 104 or 122. In accordance with the preferred embodiment of the subject application, the user interfaces 106 and 124 are advantageously used to communicate information to the associated user and to receive selections from the associated user. The skilled artisan will appreciate that the user interfaces 106 and 124 comprise various components suitably adapted to present data to the associated user, as are known in the art. In accordance with one embodiment of the subject application, the user interfaces 106 and 124 comprise a display suitably adapted to display one or more graphical elements, text data, images, or the like to an associated user; to receive input from the associated user; to and communicate the same to a backend component, such as the controllers 108 and 126, as explained in greater detail below. Preferably, the document processing devices 104 and 122 are communicatively coupled to the computer network 102 via respective communications links 112 and 130. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104 and 122 will be better understood in conjunction with the block diagrams illustrated in FIGS. 2 and 3, explained in greater detail below.

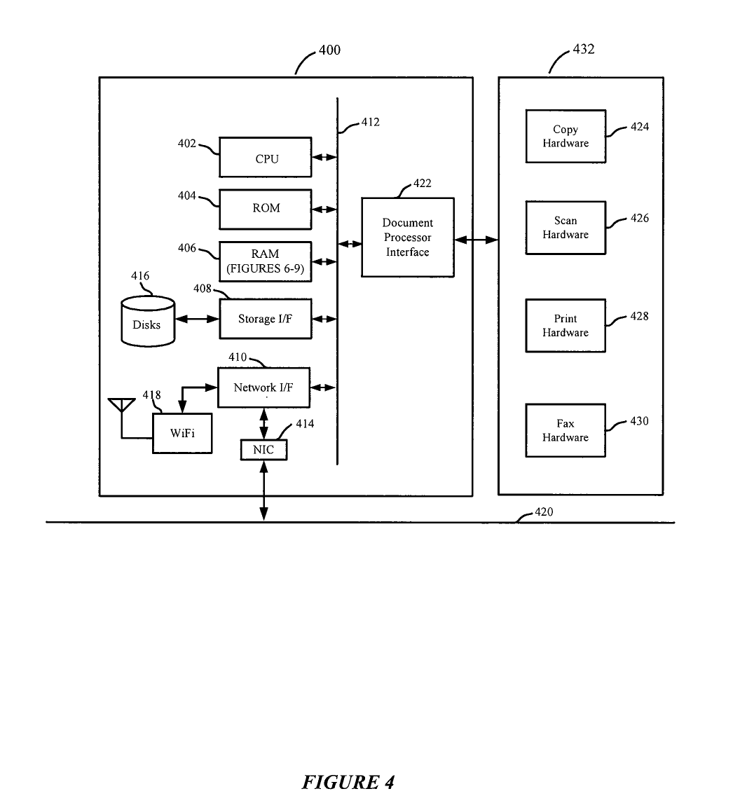

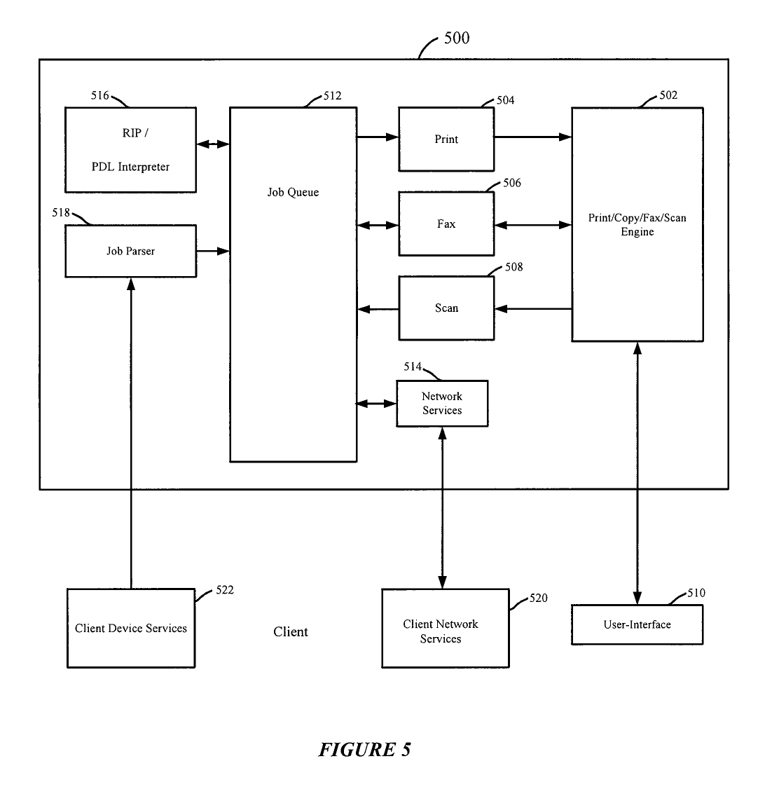

In accordance with one embodiment of the subject application, the document processing devices 104 and 122 each incorporate a backend component, designated as the controllers 108 and 126, suitably adapted to facilitate the operations of the document processing devices 104 and 122, as will be understood by those skilled in the art. Preferably, the controllers 108 and 126 are embodied as hardware, software, or any suitable combination thereof configured to control the operations of the associated document processing device 104 or 122, to facilitate the display of images via the user interfaces 106 or 124, to direct the manipulation of electronic image data, and the like. For purposes of explanation, the controllers 108 and 126 are used to refer to any of the myriad components associated with the document processing device 104 or 122, including hardware, software, or combinations thereof functioning to perform, cause to be performed, control, or otherwise direct the methodologies described hereinafter. It will be understood by those skilled in the art that the methodologies described with respect to the controllers 108 and 126 are capable of being performed by any general purpose computing system known in the art, and thus the controllers 108 and 126 are representative of such general computing devices and are intended as such when used hereinafter. Furthermore, the use of the controllers 108 and 126 hereinafter is for the example embodiment only, and other embodiments, which will be apparent to one skilled in the art, are capable of employing the document processing system and method having peer device feature discovery and job routing. The functioning of the controllers 108 and 126 will better be understood in conjunction with the block diagrams illustrated in FIGS. 4 and 5, explained in greater detail below.

Communicatively coupled to the document processing devices 104 and 122 are data storage devices 110 and 128, respectively. In accordance with the one embodiment of the subject application, the data storage devices 110 and 128 are any mass storage device known in the art including, for example and without limitation, magnetic storage drives, hard disk drives, optical storage devices, flash memory devices, or any suitable combination thereof. In one embodiment, the data storage devices 110 and 128 are suitably adapted to store data records, user information, cellular telephone data, pre-set payment data, document data, image data, electronic database data, or the like. It will be appreciated by those skilled in the art that, while illustrated in FIG. 1 as being separate components of the system 100, the data storage devices 110 and 128 are capable of being implemented as internal storage components of the document processing devices 104 and 122, components of the controllers 108 and 126, or the like such as, for example and without limitation, internal hard disk drives or the like. In accordance with one embodiment of the subject application, the data storage devices 110 and 128 are capable of storing document processing instructions, usage data, user interface data, job control data, controller status data, component execution data, images, advertisements, user information, location information, output templates, mapping data, multimedia data files, fonts, and the like.

Illustrated in FIG. 1 are kiosks 114 and 132 communicatively coupled to the document processing devices 104 and 122 and, in effect, the computer network 102. It will be appreciated by those skilled in the art that the kiosks 114 and 132 are capable of being implemented as separate components of the document processing devices 104 and 122 or as integral components thereof. Use of the kiosks 114 and 132 in FIG. 1 is for example purposes only, and the skilled artisan will appreciate that the subject application is capable of implementation without the use of the kiosks 114 and 132. In accordance with one embodiment of the subject application, the kiosks 114 and 132 include associated displays 116 and 134 and user input devices 118 and 136. As will be understood by those skilled in the art, the kiosks 114 and 132 are capable of implementing a combination user input device/display such as a touch screen interface. According to one embodiment of the subject application, the kiosks 114 and 132 are suitably adapted to display prompts to an associated user, to receive document processing instructions from the associated user, to receive payment data, to receive selection data from the associated user, and the like. Preferably, the kiosks 114 and 132 include a magnetic card reader, conventional bar code reader, or the like suitably adapted to receive and read payment data from a credit card, coupon, debit card, or the like.

The system 100 of FIG. 1 also includes portable storage device readers 120 and 138, respectively coupled to the kiosks 114 and 132, which are suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

Depicted in FIG. 1 is a user device 140, illustrated as a personal computer in data communication with the computer network 102 via a communications link 142. It will be appreciated by those skilled in the art that the user device 140 is shown in FIG. 1 as a computer workstation for illustration purposes only. As will be understood by those skilled in the art, the user device 140 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 142 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 140 is suitably adapted to receive status data, job data, user interface data, and/or image data; to monitor document processing jobs; to employ thin-client interfaces; to generate display data; to generate output data; or the like with respect to the document processing devices 104 and 122, or any other similar device coupled to the computer network 102.

The system 100 illustrated in FIG. 1 further depicts a backend component, shown as the server 144, in data communication with the computer network 102 via a communications link 148. It will be appreciated by those skilled in the art that the server 144 is shown in FIG. 1 as a component of the system 100 for example purposes only, and the subject application is capable of implementation without the use of a separate backend server component. The skilled artisan will appreciate that the server 144 comprises hardware, software, or combinations thereof suitably adapted to provide one or more services, web-based applications, storage options, or the like to networked devices. In accordance with one example embodiment of the subject application, the server 144 includes various components, implemented as hardware, software, or a combination thereof for managing retention of secured documents and/or text data, performing searches and/or comparisons, maintaining data records and/or account information, receiving payment data, retrieving documents, and the like, which are accessed via the computer network 102. The communications link 148 is any suitable data communications means known in the art including but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system or wired communications known in the art. It will further be appreciated by those skilled in the art that the components described with respect to the server 144 are capable of implementation on any suitable computing device coupled to the computer network 102, e.g. the controllers 108 and 126, or the like.

Communicatively coupled to the server 144 is the data storage device 146. According to the foregoing example embodiment, the data storage device 146 is any mass storage device, or plurality of such devices, known in the art including, for example and without limitation, magnetic storage drives, a hard disk drive, optical storage devices, flash memory devices, or any suitable combination thereof. In such an embodiment, the data storage device 146 is suitably adapted to store software updates, secured electronic documents, text data, data strings, account information, policy information, and the like. It will be appreciated by those skilled in the art that, while illustrated in FIG. 1 as being a separate component of the system 100, the data storage device 146 is capable of being implemented as an internal storage component of the server 144 or the like such as, for example and without limitation, an internal hard disk drive or the like.

Turning now to FIG. 2, illustrated is a representative architecture of a suitable device 200, shown in FIG. 1 as the document processing devices 104 and 122, on which operations of the subject system 100 are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing devices 104 and 122, for use in connection with the disclosed system 100. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices so as to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controllers 108 and 126, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104 and 122, which includes the controller 400 of FIG. 4 (shown in FIG. 1 as the controllers 108 and 126) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

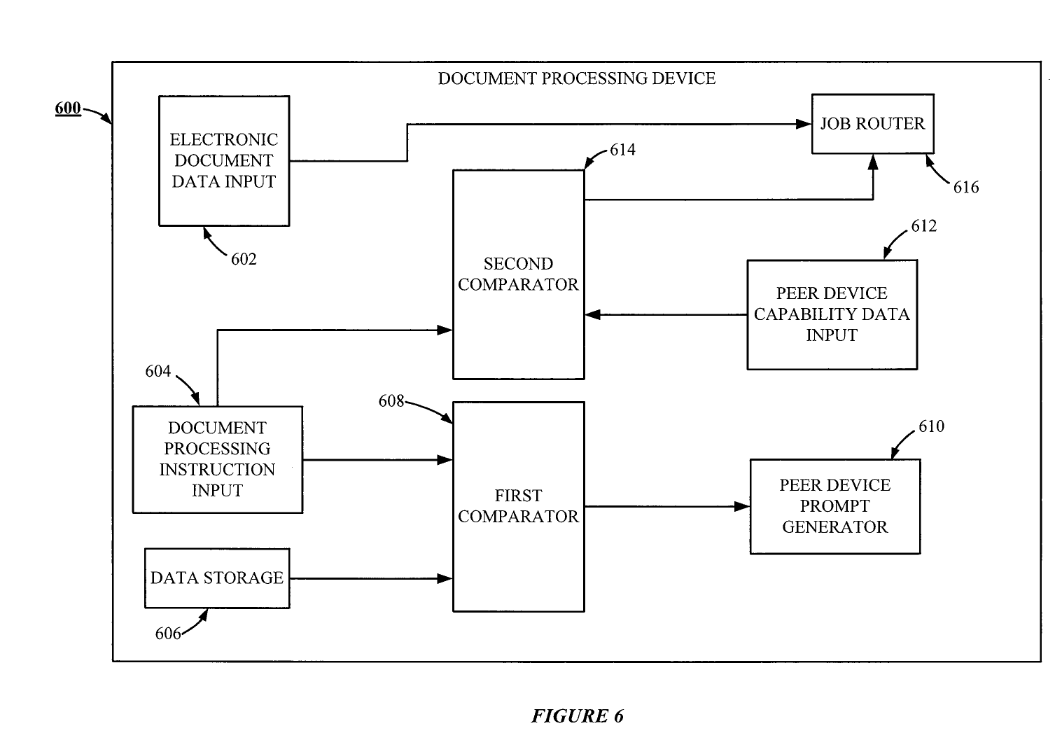

Turning now to FIG. 6, illustrated is a block diagram of a document processing device 600 having peer device feature discovery and job routing in accordance with one embodiment of the subject application. The document processing device 600 includes an electronic document data input 602 configured to receive an electronic document and the features desired for processing the document by the document processing device 600. The document processing device 600 further includes a document processing instruction input 604 configured to receive document processing instructions from an associated user. A data storage 606 is also available to the document processing device 600 that stores feature data corresponding to available operation features associated with the document processing device 600. The device 600 further includes a first comparator 608 configured to compare instruction data and feature data, as well as a peer device prompt generator 610 that operates in accordance with the output of the comparator 608. That is, if the feature data and the instruction data match, no signal is communicated to the peer device prompt generator 610, while if the feature data and instruction data indicate that the document processing device 600 lacks the features requested by the instruction data, a signal is communicated to the peer device prompt generator 610.

A peer device capability data input 612 of the document processing device 600 then receives peer device capability data from a peer device in response to the prompt from the peer device prompt generator 610. The document processing device 600 also includes a second comparator 614 for comparing the instruction data from the document processing instruction input 604 and peer device capability data received from the input 612 so as to determine whether the peer device is capable of performing the requested operation. An output of the second comparator 614 is then received by a job router 616, which routes electronic document data received via the input 604 to the peer device when the second comparator 614 output indicates the peer device is capable of completing the requested operation.

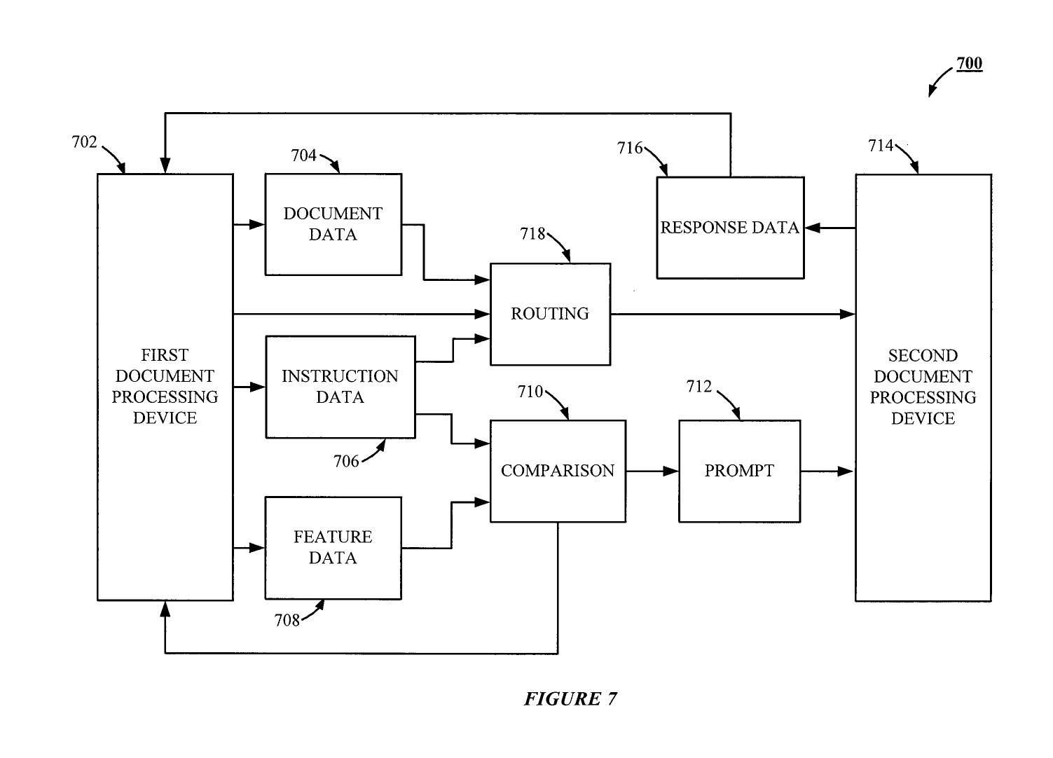

Referring now to FIG. 7, there is shown a functional diagram 700 illustrating the document processing system 100 having peer device feature discovery and job routing in accordance with one embodiment of the subject application. Document data 704 and instruction data 706 are first received from a first document processing device 702 corresponding respectively to an electronic document and a document processing operation to be performed on the electronic document. A comparison 710 is then performed between feature data 708 and the received instruction data 706 so as to determine whether the first document processing device 702 has the necessary features to perform the operation indicated by the instruction data 706.

When the comparison 710 indicates that the first document processing device 702 is not able to complete the operation of the instruction data 706, a prompt 712 is made to a second document processing device 714 for information relative to the features or capabilities of the second document processing device 714. Response data 716 is then communicated from the second document processing device 714 to the first document processing device 702 inclusive of capability and/or feature data associated with the second document processing device 714. Routing 718 is then performed upon document data 704 and instruction data 706 in accordance with the response data 716 received from the second document processing device 714.

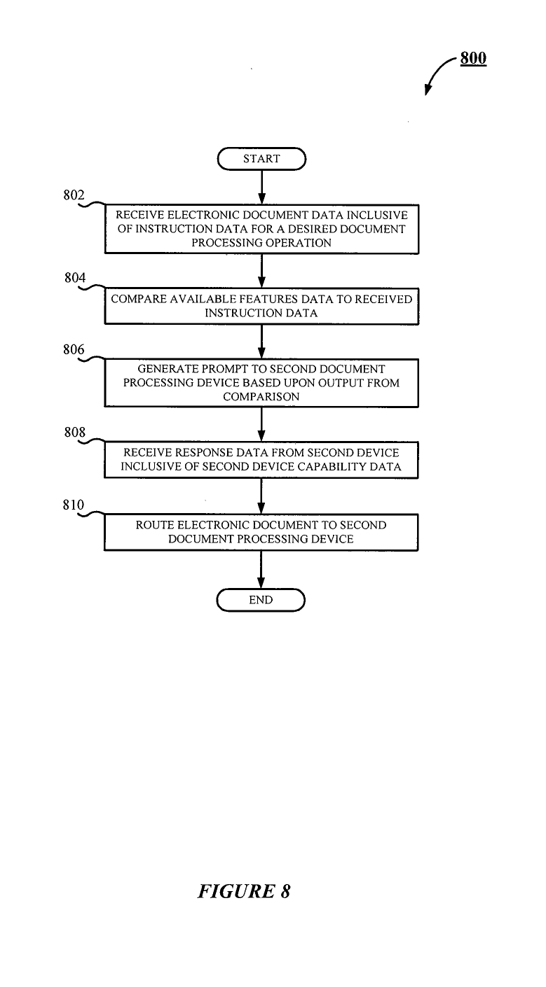

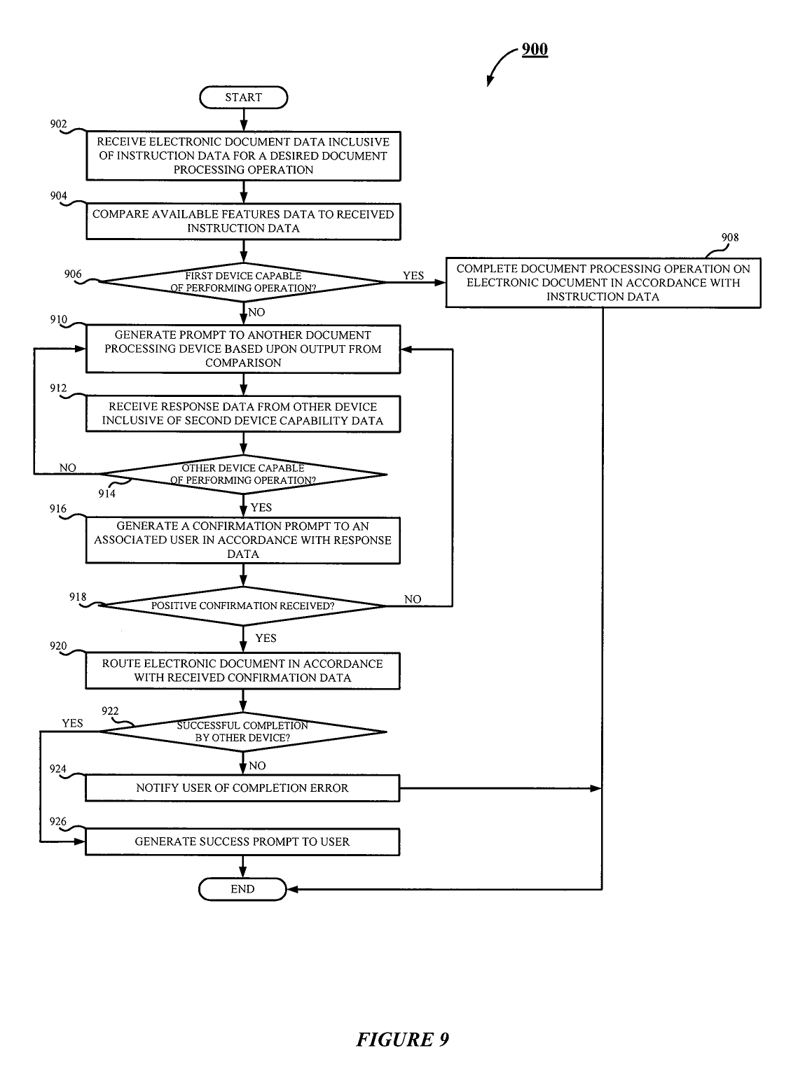

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a document processing method having peer device feature discovery and job routing in accordance with one embodiment of the subject application. Beginning at step 802, electronic document data is received by the controller 108 from the first document processing device 104 inclusive of data corresponding to at least one electronic document and instruction data corresponding to at least one desired document processing operation associated with the electronic document.

At step 804, the controller 108 or other suitable component associated with the document processing device 104 compares the feature data associated with the document processing device 104 relative to the instruction data. The controller 108 then generates a prompt at step 806 to at least one second document processing device 122 in accordance with an output of the comparison at step 804 indicating that the first document processing device 104 has insufficient capabilities to perform the desired document processing operation. The controller 108 or other suitable component associated with the first document processing device 104 then receives response data from the second document processing device 122 in accordance with the generated prompt at step 808. According to one embodiment of the subject application, the response data includes, for example and without limitation, data corresponding to capabilities of the second document processing device 122 relative to the desired document processing operation. Thereafter, the controller 108 or other suitable component associated with the first document processing device 104 routes the electronic document data to the second document processing device 122 in accordance with received response data at step 810.

Referring now to FIG. 9, there is shown a flowchart 900 illustrating a document processing method having peer device feature discovery and job routing in accordance with one embodiment of the subject application. The methodology of FIG. 9 begins at step 902, whereupon the controller 108 or other suitable component associated with the first document processing device 104 receives electronic document data from a document processing device (e.g. the user device 140, the document processing device 104, or other such device in data communication with the controller 108). Preferably, the electronic document data includes data representative of at least one electronic document and instruction data representing instructions for performing at least one associated document processing operation.

The controller 108 or other suitable component associated with the first document processing device 104 then compares feature data associated with the first document processing device 104 relative to the instruction data at step 904. That is, the controller 108 compares the functionality of the first document processing device 104 with the requested functionality of the document processing operation. Suitable features associated with the document processing device 104 and instruction data include, for example and without limitation, different or alternative sheet stock, hole-punching, stapling, duplexing, n-up generation, collation, toner colors, scanning, facsimile transmissions, and the like. A determination is then made at step 906 as to whether the first document processing device 104 is capable of performing the requested operation. Upon a determination by the controller 108 that the first document processing device 104 includes the features necessary to perform the document processing operation requested by the instruction data, flow progresses from step 906 to step 908. At step 908, the first document processing device 104 completes the document processing operation on the electronic document data in accordance with the received instruction data.

When it is determined at step 906 that the first document processing device 104 is not capable of performing the requested document processing operation, flow proceeds to step 910. At step 910, the controller 108 generates a prompt to another document processing device, e.g. the second document processing device 122, for information relative to the capabilities, e.g. features, associated with the second document processing device 122. It will be appreciated by those skilled in the art that, while only two document processing devices 104 and 122 are illustrated in FIG. 1 and described in conjunction with FIG. 9, any number of such devices of the same or varying capabilities is capable of implementation in accordance with the subject application. The second document processing device 122 then generates a response to the prompt from the first document processing device 104, preferably including feature data representative of the features available via the second document processing device 122. At step 912, the controller 108 or other suitable component associated with the first document processing device 104 receives response data from the other document processing device 122 inclusive of its associated capabilities.

A determination is then made by the controller 108 at step 914 as to whether the second document processing device 122 is capable of performing the requested document processing operation based upon a comparison of the feature data received in the response relative to the instruction data. Upon a negative determination at step 914, flow returns to step 910, whereupon the controller 108 generates a prompt to another document processing device (e.g. a third device, not shown) as set forth above. When it is determined at step 914 that the other document processing device 122 is capable of performing the requested document processing operation, flow progresses to step 916, whereupon the controller 108 or other suitable component associated with the first document processing device 104 generates a confirmation prompt to an associated user for confirmation of the capability of the second document processing device 122 to perform the requested operation. Preferably, the prompt is generated via the user interface 106, the kiosk 114, a thin-client interface associated with the user device 140, or the like and includes identification data identifying the second document processing device 122 for the associated user.

A determination is then made at step 918 as to whether confirmation data indicative of a positive confirmation of the second document processing device 122 has been received from the associated user. When the user has not confirmed the second document processing device 122 for performance of the requested operation, flow returns to step 910, whereupon the controller 108 generates a prompt to another document processing device, as set forth in greater detail above. Following receipt of positive confirmation at step 918, flow proceeds to step 920, whereupon the electronic document is routed to the second document processing device 122 in accordance with the received confirmation data.

The controller 108 or other suitable component associated with the first document processing device 104 then determines, at step 922, whether the second document processing device 122 has successfully completed the requested document processing operation. A negative determination at step 922 prompts a notification to the associated user of the completion error at step 924. A positive determination at step 922 prompts the generation of a success prompt to the associated user at step 926. It will be appreciated by those skilled in the art that such a prompt is capable of being displayed via the user interface 106, the kiosk 114, a thin-client operable on the user device 140, or the like. The skilled artisan will further appreciate that, while reference was made above with respect to the controller 108 facilitating the methodology of FIG. 9, the subject application is also capable of being implemented via the user device 140 or other suitable computing device coupled to the computer network 102, as will be known in the art.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A document processing device having peer device feature discovery and job routing, comprising:
an electronic document data input;
a document processing instruction data input;
a data storage including feature data corresponding to available operation features;
a first comparator of instruction data and feature data;
a peer device prompt generator operable in accordance with an output of the comparator;
a peer device capability data input;
a second comparator of instruction data and peer device capability data; and
a job router for received electronic document data input operable in accordance with an output of the peer device capability data input.

2. The system of claim 1, further comprising an electronic document router operable in accordance with an output of the second comparator.

3. The system of claim 2, further comprising a user confirmation input and wherein the electronic document router is further operable in accordance with an output of the user confirmation input.

4. The system of claim 3, wherein the peer device prompt generator includes a prompt generator operable in accordance with processing instruction data.

5. The system of claim 4, further comprising a job completion prompt generator operable in accordance with completed processing of electronic document data input by a peer device associated with an output of the peer device prompt.

6. A document processing method having peer device feature discovery and job routing, comprising the steps of:
receiving electronic document data from an associated document processing device, which electronic document data includes data corresponding to at least one electronic document and instruction data corresponding to at least one desired document processing operation associated with the at least one electronic document;
comparing data corresponding to available features of the document processing device relative to received instruction data;
generating a prompt to at least a second document processing device in accordance with an output of the comparison indicative of the document processing device having insufficient capabilities to perform the desired document processing operation;
receiving response data from the second document processing device in accordance with a generated prompt, which response data includes data corresponding to capabilities of the second document processing device relative to the desired document processing operation; and
routing the electronic document data to the second document processing device in accordance with received response data.

7. The method of claim 6, further comprising the step of generating a confirmation prompt to an associated user in accordance with received response data.

8. The method of claim 7, further comprising the steps of:
receiving, from the associated user, confirmation data corresponding to the generated prompt; and
routing the electronic document in accordance with received confirmation data.

9. The method of claim 7, wherein the confirmation prompt includes data corresponding to an identity of the second document processing device.

10. The method of claim 7, further comprising the step of generating a success prompt to the associated user, which success prompt is indicative of successful completion of the document processing operation by the second document processing device.

11. A document processing system having peer device feature discovery and job routing, comprising:
means adapted for receiving electronic document data from an associated document processing device, which electronic document data includes data corresponding to at least one electronic document and instruction data corresponding to at least one desired document processing operation associated with the at least one electronic document;
comparison means adapted for comparing data corresponding to available features of the document processing device relative to received instruction data;
means adapted for generating a prompt to at least a second document processing device in accordance with an output of the comparison means indicative of the document processing device having insufficient capabilities to perform the desired document processing operation;
means adapted for receiving response data from the second document processing device in accordance with a generated prompt, which response data includes data corresponding to capabilities of the second document processing device relative to the desired document processing operation; and
routing means adapted for routing the electronic document data to the second document processing device in accordance with received response data.

12. The system of claim 11, further comprising means adapted for generating a confirmation prompt to an associated user in accordance with received response data.

13. The system of claim 12, further comprising:
means adapted for receiving, from the associated user, confirmation data corresponding to the generated prompt; and
wherein the routing means further include means adapted for routing the electronic document in accordance with received confirmation data.

14. The system of claim 12, wherein the confirmation prompt includes data corresponding to an identity of the second document processing device.

15. The system of claim 12, further comprising means adapted for generating a success prompt to the associated user, which success prompt is indicative of successful completion of the document processing operation by the second document processing device.
